(19) United States
(12) Patent Application Publication
(10) Pub. No.: US 2006/0162127 A1
(43) Pub. Date: Jul. 27, 2006

(54) Fixing structure for a door handle

(75) Inventors: Lan-Shi Huang, Kaohsiung (TW); Kuang-Chun Chiang, Kaohsiung Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: TAIWAN FU HSING INDUSTRIAL CO., LTD., Kaohsiung Hsien (TW)

(21) Appl. No.: 11/041,574

(22) Filed: Jan. 24, 2005

(51) Int. Cl. E05B 1/00

(52) U.S. Cl. 16/412

(57) ABSTRACT

A fixing structure for a door handle includes a grip portion, a first fixing portion connected to a first end of the grip portion and fixed to a side of a door, and a second fixing portion connected to a second end of the grip portion and fixed to the side of a door. A guiding plate is fixedly mounted to the second fixing portion. At least one fixing tube is slidably mounted to the guiding plate, thereby adjusting a mounting position of the at least one fixing tube.

### BACKGROUND OF THE INVENTION

1. Field of the Invention The present invention relates to a fixing structure for a handle. In particular, the present invention relates to a fixing structure for a door handle.

2. Description of Related Art

FIG. 1 of the drawings illustrates a conventional door handle comprising a grip portion 1, a first fixing portion 2, and a second fixing portion 3. The grip portion 1 has two ends respectively connected to the first portion 2 and the second fixing portion 3. The first and second fixing portions 2 and 3 are used to fix the handle to a door 4. The first fixing portion 2 includes a plurality of screw holes 21, and the second fixing portion 3 includes a fixing tube 31 with an inner threading. The door 4 includes a plurality of first mounting holes 41 associated with the screw holes 21 of the first fixing portion 2, and a plurality of first screws 22 are extended through the first fixing holes 41 into the screw holes 21. The door 4 further includes a second mounting hole 42, and a second screw 32 is extended through the second mounting hole 42 to engage with the inner threading of the fixing tube 31. The handle is thus screwed to the door 4.

However, since the screw holes 21 are integrally formed on the first fixing portion 2 and since the fixing tube 31 is integrally formed on the second fixing portion 3, the distance from the fixing tube 31 to each of the screw holes 21 is fixed. Hence, drilling of the first mounting holes 41 and the second mounting hole 42 must be carefully proceeded to make the first mounting holes 41 and the second mounting hole 42 exactly align with the screw holes 21 and the fixing tube 31 respectively. However, precise drilling of the first mounting holes 41 and the second mounting hole 42 could not be achieved every time, leading to troublesome mounting of the handle to the door 4.

### OBJECTS OF THE INVENTION

An object of the present invention is to provide a fixing structure for a door handle that allows easy, flexible mounting of the door handle to a door.

### SUMMARY OF THE INVENTION

A fixing structure for a door handle in accordance with the present invention comprises a grip portion, a first fixing portion connected to a first end of the grip portion and fixed to a side of a door, and a second fixing portion connected to a second end of the grip portion and fixed to the side of a door. A guiding plate is fixedly mounted to the second fixing portion. At least one fixing tube is slidably mounted to the guiding plate, thereby adjusting a mounting position of the at least one fixing tube.

The at least one fixing tube includes a movable plate fixed to an end thereof.

In an embodiment of the invention, the second fixing portion further includes a groove for slidingly receiving the movable plate. The guiding plate further includes a slot through which the at least one fixing tube extends. An elastic element is mounted between a bottom wall delimiting the groove and the movable plate to bias the movable plate to press against the guiding plate, thereby retaining the at least one fixing tube in place. The guiding plate further comprises two abutting flanges on two lateral edges delimiting the slot, and the movable plate abuts against the abutting flanges.

In another embodiment of the invention, the movable plate is substantially C-shaped and slidably embraces two lateral sides of the guiding plate. The second fixing portion further includes at least one protrusion to which the guiding plate is fixedly mounted.

Preferably, a latch mechanism and a linking mechanism are mounted to the first fixing portion to provide a locking/unlocking structure.

Other objects, advantages and novel features of this invention will become more apparent from the following detailed description when taken in conjunction with the accompanying drawings.

### BRIEF DESCRIPTION OF THE DRAWINGS

FIG. 1 is an exploded sectional view of a conventional fixing structure for a door handle and a door;

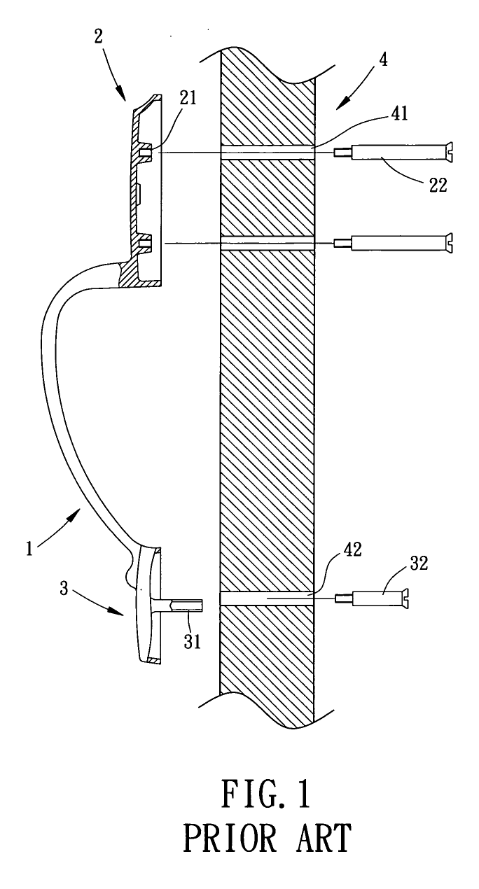

FIG. 2 is an exploded perspective view of an embodiment of a fixing structure for a door handle in accordance with the present invention and a door;

FIG. 3 is an exploded perspective view of a second fixing portion of the fixing structure in accordance with the present invention;

FIG. 4 is a sectional view of the fixing structure in accordance with the present invention and a door;

FIG. 5 is an enlarged view of a circled portion in FIG. 4;

FIG. 6 is a sectional view similar to FIG. 4, illustrating flexible mounting of the door handle; and

FIG. 7 is an exploded perspective view illustrating a modified embodiment of the second fixing portion of the fixing structure in accordance with the present invention.

### DETAILED DESCRIPTION OF THE PREFERRED EMBODIMENTS

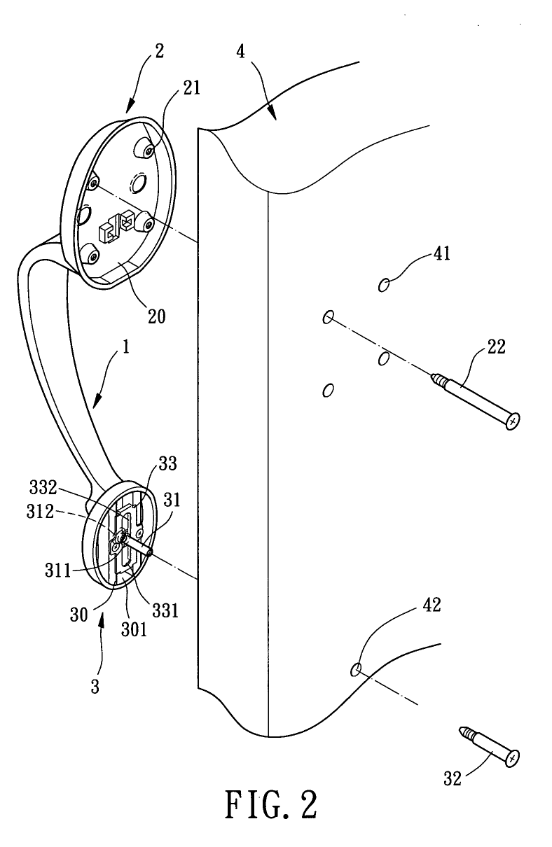

Referring to FIG. 2, an embodiment of a fixing structure for a door handle in accordance with the present invention comprises a grip portion 1, a first fixing portion 2, and a second fixing portion 3. The grip portion 1 includes two ends respectively connected to the first fixing portion 2 and the second fixing portion 3. The first fixing portion 2 and the second fixing portion 3 are used to fix the handle to a door 4. A latch mechanism (not shown) and/or a linking mechanism (not shown) can be mounted in the first fixing portion 2 to form a lock for controlling locking/unlocking of the door 4.

Still referring to FIG. 2, the first fixing portion 2 includes a first engaging face 20 with a plurality of screw holes 21. The first engaging face 20 is fixedly coupled to a side of the door 4. The second fixing portion 3 includes a second engaging face 30, at least one fixing tube 31 (only one in the illustrated embodiment) on the second engaging face 30, and a guiding plate 33 on the second engaging face 30. The second engaging face 30 is fixedly coupled to the side of the door 4. The fixing tube 31 includes an inner threading (not labeled).

Referring to FIGS. 2 through 4, the door 4 includes a plurality of first mounting holes 41 associated with the screw holes 21 of the first fixing portion 2. A plurality of first screws 22 are extended from the other side of the door 4 through the first mounting holes 41 into the screw holes 21, thereby fixedly screwing the first fixing portion 2 to the side of the door 4. The door 4 further includes at least one second mounting hole 42 (only one in the illustrated embodiment) associated with the fixing tube 31. A second screw 32 is extended from the other side of the door 4 through the second mounting hole 42 into the fixing tube 31, thereby fixedly screwing the second fixing portion 3 to the side of the door 4.

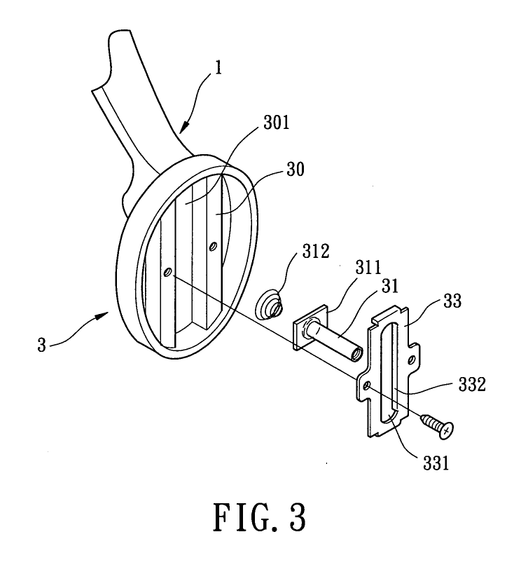

Still referring to FIGS. 2 and 3, the second engaging face 30 of the second fixing portion 3 includes a groove 301. A movable plate 311 is fixed to the fixing tube 32 and slidably received in the groove 301. An elastic element 312 is mounted between a bottom wall delimiting the groove 301 and the movable plate 311 for biasing the fixing tube 32 toward the guiding plate 33. The movable plate 311 has a width slightly smaller than that of the groove 301.

The guiding plate 33 is an elongated metal plate fixed by screws (not labeled) to the second engaging face 30 and includes a slot 331 through which the fixing tube 31 extends. The slot 331 has a width slightly greater than an outer diameter of the fixing tube 31 and slightly smaller than the width of the movable plate 311. Thus, the movable plate 311 is biased by the elastic element 312 to press against the guiding plate 33. Preferably, the guiding plate 33 includes two abutting flange 332 respectively formed on two lateral edges delimiting the slot 331. The movable plate 311 firmly presses against the abutting flanges 332 under the action of the elastic element 312.

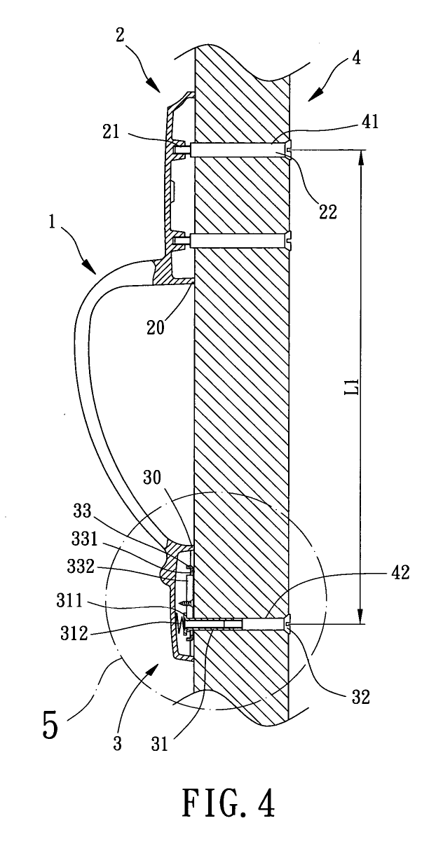

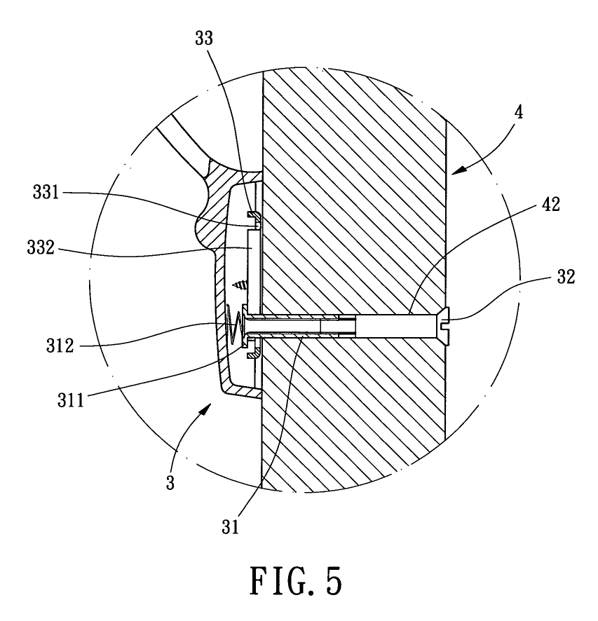

Referring to FIGS. 4 and 5, when mounting the door handle to a door 4 of a certain specification (the distance from the second mounting hole 42 to the uppermost mounting hole 41 is L1), the first screws 22 are extended from the other side of the door 4 through the first mounting holes 41 into the screw holes 21, thereby fixedly screwing the first fixing portion 2 to the side of the door 4. Next, the fixing tube 31 is moved along the slot 331 of the guiding plate 33 until the fixing tube 31 is aligned with the second mounting hole 42 of the door 4. The second screw 32 is extended from the other side of the door 4 through the second mounting hole 42 into the fixing tube 31, thereby fixedly screwing the second fixing portion 3 to the side of the door 4. The door handle is thus firmly fixed to the door 4.

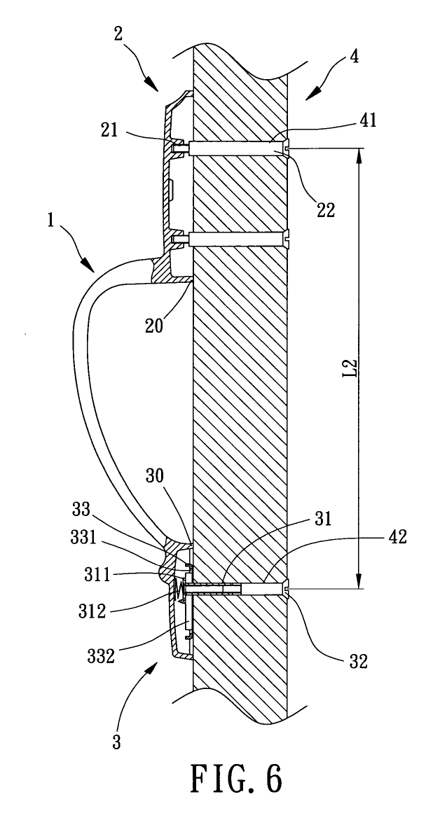

Referring to FIG. 6, when mounting the door handle to a door 4 of another specification (the distance from the second mounting hole 42 to the uppermost mounting hole 41 is L2), the first screws 22 are extended from the other side of the door 4 through the first mounting holes 41 into the screw holes 21, thereby fixedly screwing the first fixing portion 2 to the side of the door 4. Next, the fixing tube 31 is moved along the slot 331 of the guiding plate 33 until the fixing tube 31 is aligned with the second mounting hole 42 of the door 4. The second screw 32 is extended from the other side of the door 4 through the second mounting hole 42 into the fixing tube 31, thereby fixedly screwing the second fixing portion 3 to the side of the door 4. The door handle is thus firmly fixed to the door 4.

Thus, the door handle can be mounted to the door 4 with greater flexibility. In other words, precise drilling of the first mounting holes 41 and the second mounting hole 42 in the door 4 is no requisite. And mounting of the door handle to the door 4 is easy.

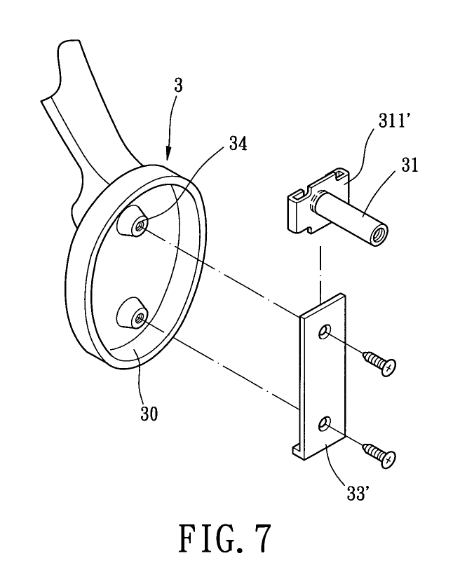

FIG. 7 shows a modified embodiment of the second fixing portion of the invention. In this embodiment, the second engaging face 30 includes two protrusions 34, and a guiding plate 33′ is screwed to the protrusions 34 by fasteners (not labeled). Further, a substantially C-shaped movable plate 311′ is fixed on an end of the fixing tube 31. The C-shaped movable plate 311′ embraces two lateral side of the guiding plate 33′ and is slidable along the guiding plate 33′. Thus, the C-shaped movable plate 311′ can be moved to a desired position in which the fixing tube 31 is aligned with the second mounting hole 42 of the door 4 for assembling purposes.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A fixing structure for a door handle, comprising:
a grip portion including a first end and a second end;
a first fixing portion connected to the first end of the grip portion, the first fixing portion being adapted to be fixed to a side of a door;
a second fixing portion connected to the second end of the grip portion, the second fixing portion being adapted to be fixed to the side of a door;
a guiding plate fixedly mounted to the second fixing portion; and
at least one fixing tube slidably mounted to the guiding plate, thereby adjusting a mounting position of said at least one fixing tube.

2. The fixing structure for a door handle as claimed in claim 1, wherein said at least one fixing tube includes a movable plate fixed to an end thereof.

3. The fixing structure for a door handle as claimed in claim 2, wherein the second fixing portion further includes a groove for slidingly receiving the movable plate, the guiding plate further including a slot through which said at least one fixing tube extends.

4. The fixing structure for a door handle as claimed in claim 3, further comprising an elastic element mounted between a bottom wall delimiting the groove and the movable plate to bias the movable plate to press against the guiding plate, thereby retaining said at least one fixing tube in place.

5. The fixing structure for a door handle as claimed in claim 3, wherein the guiding plate further comprises two abutting flanges on two lateral edges delimiting the slot, and wherein the movable plate abuts against the abutting flanges.

6. The fixing structure for a door handle as claimed in claim 2, wherein the movable plate is substantially C-shaped and slidably embraces two lateral sides of the guiding plate.

7. The fixing structure for a door handle as claimed in claim 6, wherein the second fixing portion further includes at least one protrusion to which the guiding plate is fixedly mounted.

8. The fixing structure for a door handle as claimed in claim 1, further comprising a latch mechanism and a linking mechanism mounted to the first fixing portion to provide a locking/unlocking structure.
